(19) United States
(12) Patent Application Publication
(10) Pub. No.: US 2026/0265418 A1
(43) Pub. Date: Sep. 10, 2026

(54) COUPLED POLYETHYLENES OR COPOLYMERS OF ETHYLENE AND 1,3-DIENE, AND PROCESS FOR THE PREPARATION THEREOF

(71) Applicants: Compagnie Generale Des Etablissements Michelin, Clermont-Ferrand (FR); CENTRE NATIONAL DE LA RECHERCHE SCIENTIFIQUE, PARIS CEDEX 16 (FR); ECOLE SUPÉRIEURE DE CHIMIE PHYSIQUE ELECTRONIQUE DE LYON, VILLEURBANNE CEDEX (FR); UNIVERSITÉ CLAUDE BERNARD LYON 1, VILLEURBANNE CEDEX (FR)

(72) Inventors: Christophe BOISSON, Clermont-Ferrand (FR); Franck D'AGOSTO, Clermont-Ferrand (FR); Ariane DESGRANGES, Clermont-Ferrand (FR); Robert NGO, Clermont-Ferrand (FR); François JEAN-BAPTISTE-DIT-DOMINIQUE, Clermont-Ferrand (FR)

(21) Appl. No.: 18/871,789

(22) PCT Filed: May 30, 2023
(86) PCT No.: PCT/EP2023/064411

§ 371 Date: Dec. 4, 2024

(30) Foreign Application Priority Data
Jun. 9, 2022 (FR) FR2205551

(51) Int. Cl. C08F 8/12; C08F 4/54; C08F 8/30; C08F 210/02

(52) U.S. Cl. CPC C08F 8/12; C08F 4/545; C08F 8/30; C08F 210/02; C08F 2410/01; C08F 2420/01

(57) ABSTRACT

Coupled polyethylenes and coupled copolymers of ethylene and a 1,3-diene and optionally a vinylaromatic compound, which contain more than 50 mol % of ethylene are provided. A process for preparing the coupled polyethylenes and coupled copolymers, which comprises a polymerization reaction of the monomers in the presence of a borohydrido-neodymocene complex and an organomagnesium halide, followed by a coupling reaction with a compound containing at least two nitrile functions, each preferentially being a substituent of a same or a different aromatic group, followed by a hydrolysis reaction, is also provided.

### CROSS REFERENCE TO RELATED APPLICATIONS

This U.S. patent application is a national phase entry of PCT Patent Application No. PCT/EP2023/064411, filed May 30, 2023, which claims priority to French Patent Application No. FR2205551, filed Jun. 9, 2022, the entire contents of which are incorporated herein by reference in their entirety.

### BACKGROUND

### 1. Technical Field

The field of the invention is that of polyethylenes and copolymers of ethylene and α-olefins which are rich in ethylene units.

### 2. Related Art

The synthesis of coupled diene polymers is very widely described by the coupling of living polymer chains synthesized by anionic polymerization in the presence of a lithium-based initiator. The synthesis of stereospecific diene polymers by coupling polydiene chains with a high 1,4-cis bond content is less well described due to the nature of the bonds involved in the synthesis of polydiene chains with a high 1,4-cis bond content in the presence of a Ziegler Natta-type catalyst. The synthesis of coupled polybutadienes with a high 1,4-cis bond content is described, for example, in WO 2010/085631 by coupling reaction with compounds containing nitrile functions. In anionic polymerization synthesis and stereospecific polymerization synthesis, the reactions involve 6-alkyllithium bonds, i.e. η²-alkyl-Li, or π-allyl complexes, i.e. η³-allylic bonds.

The synthesis of diene polymers rich in ethylene units is performed by polymerization of ethylene and a 1,3-diene in the presence of a catalytic system based on a borohydrido-neodymocene complex and an organomagnesium reagent. This polymerization differs from the other polymerizations mentioned in that its polymerization mechanism proceeds via numerous chain transfer reactions between the neodymium atom and the magnesium atom, and involves totally different reactive species. Reference may be made, for example, to the articles ACS Catalysis (2016), 6, 1028-1036 and ACS Catalysis (2019), 9, 9298-9309.

### SUMMARY

The Applicants have developed a process that allows the preparation of ethylene-rich coupled polymers. The process is applicable to both polyethylenes and diene copolymers that are rich in ethylene, and also has the advantage of leading to high degrees of coupling in particular embodiments of the invention.

A first subject of the invention is a process for preparing a coupled polymer which contains more than 50 mol % of ethylene, expressed as a molar percentage relative to all of the monomer units of the polymer, the polymer being a polyethylene or a copolymer of ethylene and a 1,3-diene and optionally a vinylaromatic compound, which process comprises the successive steps a), b) and c):
step a) being a polymerization reaction of the monomers in the presence of a catalytic system based on at least one metallocene of formula (I) and an alkylmagnesium halide of formula (II)

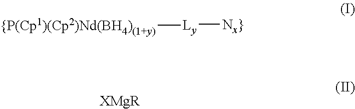

Cp¹ and Cp², which are identical or different, being chosen from the group consisting of fluorenyl groups, cyclopentadienyl groups and indenyl groups, the groups being substituted or unsubstituted,
P being a group bridging the two groups Cp¹ and Cp² and comprising a silicon or carbon atom,
Nd denoting the neodymium atom,
L representing an alkali metal chosen from the group consisting of lithium, sodium and potassium,
N representing a molecule of an ether,
x, which may or may not be an integer, being greater than or equal to 0,
y, which is an integer, being greater than or equal to 0,
X being a halogen atom and R being an alkyl,
step b) being the reaction of the reaction product of step a) with a compound containing at least two nitrile functions, each preferentially being a substituent of a same or a different aromatic group,
step c) being a hydrolysis reaction,
the polymer being a polyethylene or a copolymer of ethylene and a 1,3-diene and optionally a vinylaromatic compound.

A second subject of the invention is a coupled polymer, a polymer consisting of polymer chains which contain more than 50 mol % of ethylene units and which are linked together by a group containing at least two ketone functions, each of the ketone functions being covalently bonded to a monomer unit of a different polymer chain, which polymer is a polyethylene, a copolymer of ethylene and a 1,3-diene and optionally a vinylaromatic compound, which polymer may be obtained via the process in accordance with the invention.

### DETAILED DESCRIPTION OF EXAMPLE EMBODIMENTS

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b).

Unless otherwise indicated, the contents of the units resulting from the insertion of a monomer into a polymer are expressed as molar percentage relative to all of the units resulting from the polymerization of the monomers.

The compounds mentioned in the description may be of fossil origin or may be biobased. In the latter case, they may be partially or totally derived from biomass or may be obtained from renewable starting materials derived from biomass. Similarly, the compounds mentioned may also originate from the recycling of already-used materials, i.e. they may partially or totally result from a recycling process, or else be obtained from starting materials which themselves result from a recycling process.

The term “based on” used to define the constituents of the catalytic system means the mixture of these constituents, or the product of the reaction of a portion or all of these constituents with each other.

Step a) of the process in accordance with the invention is a polymerization reaction which allows the preparation of polymer chains, growing chains intended to react in the following step, step b), with a coupling agent, a compound containing at least two nitrile functions. Step b) is a coupling reaction.

According to a first alternative, the polymerization reaction is the polymerization of ethylene. According to this alternative, the product of the polymerization reaction of step a) is a polymer chain whose constituent units result from the insertion of ethylene. The polymer prepared via the first alternative is an ethylene homopolymer, a polyethylene.

According to a second alternative, the polymerization reaction is the polymerization of a monomer mixture of ethylene and a 1,3-diene. According to this alternative, the reaction product of the polymerization of step a) is a polymer chain whose constituent units result from the insertion of ethylene and 1,3-diene. The polymer prepared via the second alternative is a copolymer of ethylene and a 1,3-diene.

According to a third alternative of the invention, the polymerization reaction is the polymerization of a monomer mixture of ethylene, a 1,3-diene and a vinylaromatic compound. According to this alternative, the reaction product of the polymerization of step a) is a polymer chain whose constituent units result from the insertion of ethylene, 1,3-diene and the vinylaromatic compound. The polymer prepared via the third alternative is a copolymer of ethylene, a 1,3-diene and a vinylaromatic compound.

The 1,3-diene of the monomer mixture of step a) that is useful for the purposes of the second alternative and the third alternative is a single compound, i.e. a single 1,3-diene, or is a mixture of 1,3-dienes which differ from each other in chemical structure. 1,3-dienes that are suitable for use are 1,3-dienes containing from 4 to 20 carbon atoms, such as 1,3-butadiene, isoprene, myrcene and β-farnesene, and mixtures thereof. The 1,3-diene is preferably 1,3-butadiene, isoprene, myrcene, β-farnesene or mixtures thereof, in particular a mixture of at least two of them.

The vinylaromatic compound of the monomer mixture of step a) that is useful for the purposes of the third alternative is a single compound, i.e. a single vinylaromatic compound, or is a mixture of vinylaromatic compounds which differ from each other in chemical structure. The term “vinylaromatic compound” means an aromatic compound substituted with a vinyl function of well-known formula (—CH═CH₂). Most particularly suitable as vinylaromatic compounds are those containing an aryl group substituted with a vinyl function, and more particularly those containing a phenyl group substituted with a vinyl function. The vinylaromatic compound is preferentially styrene or a styrene the benzene ring of which is substituted with alkyl groups. The vinylaromatic compound is more preferentially styrene. The copolymer prepared via a preferential embodiment of the third alternative is a copolymer of ethylene, a 1,3-diene and styrene.

Preferably, the monomer mixture to be polymerized in step a) according to the second alternative and the third alternative contains more than 50 mol % of ethylene, the percentage being expressed relative to the total number of moles of monomer in the monomer mixture of step a). When the monomer mixture contains a vinylaromatic compound, such as styrene, it preferentially contains less than 40 mol % of the vinylaromatic compound, the percentage being expressed relative to the total number of moles of monomers in the monomer mixture of step a).

The polymerization of the monomers may be performed in accordance with patent applications WO 2007/054223 A2 and WO 2007/054224 A2. The catalytic system (or catalytic composition) used to polymerize the monomers is composed of a metallocene and an alkylmagnesium halide.

In the present patent application, the term “metallocene” means an organometallic complex, the metal of which, in the case in point the neodymium atom, is bonded to a molecule named a ligand and consisting of two groups Cp¹ and Cp² connected together by a bridge P. These groups Cp¹ and Cp², which are identical or different, are chosen from the group consisting of fluorenyl groups, cyclopentadienyl groups and indenyl groups, these groups possibly being substituted or unsubstituted.

According to the invention, the metallocene used as base constituent in the catalytic system corresponds to formula (Ia)

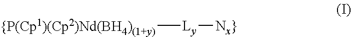

P being a group bridging the two groups Cp¹ and Cp² and comprising a silicon or carbon atom,
Cp¹ and Cp², which are identical or different, being chosen from the group consisting of fluorenyl groups, cyclopentadienyl groups and indenyl groups, the groups being substituted or unsubstituted,
Nd denoting the neodymium atom,
L representing an alkali metal chosen from the group consisting of lithium, sodium and potassium,
N representing a molecule of an ether,
x, which may or may not be an integer, being greater than or equal to 0,
y, which is an integer, being greater than or equal to 0,

In formula (I), the neodymium atom is connected to a ligand molecule consisting of the two groups Cp¹ and Cp² which are connected together by a bridge P. Preferably, the symbol P, denoted by the term bridge, corresponds to the formula ZR¹R², Z representing a silicon or carbon atom, R¹ and R², which are identical or different, representing an alkyl group comprising from 1 to 20 carbon atoms. More preferentially, the bridge P is of formula SiR¹R², R¹ and R² being identical and as defined previously. Even more preferentially, P corresponds to the formula SiMe₂.

In formula (I), any ether which has the ability to complex the alkali metal, notably diethyl ether, methyltetrahydrofuran and tetrahydrofuran, preferentially tetrahydrofuran, is suitable as ether.

As substituted cyclopentadienyl, fluorenyl and indenyl groups, mention may be made of those substituted with groups containing from 1 to 6 carbon atoms or with groups containing from 6 to 12 carbon atoms or else with trialkylsilyl groups, such as SiMe₃. When the ligands Cp¹ and Cp² are substituted, they are preferentially substituted with methyl groups, with butyl groups, notably tert-butyl groups, or with trimethylsilyl groups. The choice of the groups is also guided by the accessibility to the corresponding molecules, which are the substituted cyclopentadienes, fluorenes and indenes, since said molecules are commercially available or can be readily synthesized.

As substituted fluorenyl groups, mention may be made of those substituted in position 2, 7, 3 or 6, particularly 2,7-di(tert-butyl)fluorenyl and 3,6-di(tert-butyl)fluorenyl. The 2, 3, 6 and 7 positions respectively denote the position of the carbon atoms of the rings as represented in the diagram below, the 9 position corresponding to the carbon atom to which the bridge P is attached.

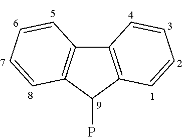

As substituted cyclopentadienyl groups, mention may be made of those substituted either in the 2 (or 5) position or in the 3 (or 4) position, particularly those substituted in the 2 position, more particularly the tetramethylcyclopentadienyl group. Position 2 (or 5) denotes the position of the carbon atom which is adjacent to the carbon atom to which the bridge P is attached, as is represented in the diagram below. As a reminder, substitution in position 2 or 5 is also referred to as substitution in the a position relative to the bridge.

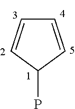

As substituted indenyl groups, mention may be made particularly of those substituted in the 2 position, more particularly 2-methylindenyl or 2-phenylindenyl. Position 2 denotes the position of the carbon atom which is adjacent to the carbon atom to which the bridge P is attached, as is represented in the diagram below.

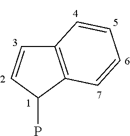

Preferably, Cp¹ and Cp², which are identical or different, are cyclopentadienyls substituted in the alpha position relative to the bridge, substituted fluorenyls, substituted indenyls or fluorenyls of formula C₁₃H₈ or indenyls of formula C₉H₆. More preferentially, Cp¹ and Cp², which are identical or different, are substituted fluorenyl groups or unsubstituted fluorenyl groups of formula C₁₃H₈. Advantageously, Cp¹ and Cp² are unsubstituted fluorenyl groups of formula C₁₃H₈, represented by the symbol Flu.

Better still, the metallocene is of formula (I-1), (I-2), (I-3), (I-4) or (I-5):

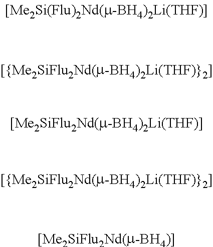

in which Flu represents the C₁₃H₈ group.

The metallocene that is useful for the synthesis of the catalytic system may be in the form of a crystalline or non-crystalline powder, or else in the form of single crystals. The metallocene may be in a monomer or dimer form, these forms depending on the method of preparation of the metallocene, as is described, for example, in patent application WO 2007/054224 A2 or WO 2007/054223 A2. The metallocene may be prepared conventionally by a process analogous to that described in patent application WO 2007/054224 A2 or WO 2007/054223 A2, notably by reaction, under inert and anhydrous conditions, of the salt of an alkali metal of the ligand with a borohydride of the rare-earth metal neodymium, in a suitable solvent, such as an ether, for instance diethyl ether or tetrahydrofuran, or any other solvent known to those skilled in the art. After reaction, the metallocene is separated from the reaction by-products via techniques known to those skilled in the art, such as filtration or precipitation from a second solvent. The metallocene is finally dried and isolated in solid form.

The alkylmagnesium halide, another basic constituent of the catalytic system, is the co-catalyst of the catalytic system. It is preferentially an alkylmagnesium chloride or an alkylmagnesium bromide, more preferentially an alkylmagnesium chloride. The alkyl may be linear or branched, preferably linear. The alkyl preferentially contains from 2 to 10 carbon atoms. Suitable alkyl groups are in particular ethyl, propyl, butyl, pentyl, hexyl, heptyl and octyl groups. More preferentially, the alkyl represented by the symbol R in formula (II) is a linear alkyl containing 2 to 10 carbon atoms. In this respect, ethylmagnesium chloride, n-butylmagnesium chloride, n-pentylmagnesium chloride, ethylmagnesium bromide, n-butylmagnesium bromide, n-pentylmagnesium bromide, n-octylmagnesium chloride and n-octylmagnesium bromide are suitable for use as alkylmagnesium halides. The alkyl represented by the symbol R in formula (II) is even more preferentially ethyl, n-propyl, n-butyl, n-pentyl or n-octyl, more preferentially n-butyl.

The compounds of formula (II) which are also Grignard reagents are well known, and some of them are even commercial products. For their synthesis, reference may also be made, for example, to the collection of volumes of “Organic Synthesis”. Like any organomagnesium compound, the alkylmagnesium halide constituting the catalytic system may be in the form of a monomeric species or in the form of a polymeric species. Moreover, whether it is in the form of a monomeric or polymeric species, the alkylmagnesium halide may also be in the form of a species coordinated to one or more molecules of a solvent, preferably of an ether such as diethyl ether, tetrahydrofuran or methyltetrahydrofuran.

The use of an alkylmagnesium halide of formula (II) in step a) of the process in accordance with the invention allows the synthesis of coupled polymers, whether it is polyethylene or a copolymer of ethylene and a 1,3-diene and optionally a vinylaromatic compound, preferably styrene.

The amounts of co-catalyst and of metallocene reacted are such that the ratio between the number of moles of Mg of the co-catalyst and the number of moles of rare-earth metal of the metallocene, neodymium, is preferably from 0.5 to 200 and more preferentially from 1 to less than 20. These preferential ranges may apply to any one of the embodiments of the invention. The range of values extending from 1 to less than 20 is notably more favourable for obtaining copolymers of high molar masses.

According to one embodiment, the catalytic system can be prepared conventionally by a process analogous to that described in patent application WO 2007/054224 A2 or WO 2007/054223 A2. For example, the cocatalyst, in this instance the alkylmagnesium halide, and the metallocene are reacted in a hydrocarbon-based solvent typically at a temperature ranging from 20° C. to 80° C. for a period of time of between 5 and 60 minutes. The catalytic system is generally prepared in an aliphatic hydrocarbon-based solvent such as methylcyclohexane, or an aromatic hydrocarbon-based solvent such as toluene. Generally, after its synthesis, the catalytic system is used as is in step a).

According to another embodiment, the catalytic system may be prepared via a process analogous to that described in patent application WO 2017/093654 A1 or in patent application WO 2018/020122 A1: it is said to be of preformed type. For example, the alkylmagnesium halide and the metallocene are reacted in a hydrocarbon-based solvent typically at a temperature of from 20° C. to 80° C. for 10 to 20 minutes to obtain a first reaction product, and a preformation monomer is then reacted with this first reaction product at a temperature ranging from 40° C. to 90° C. for 1 hour to 12 hours. The preformation monomer is preferably used in a mole ratio (preformation monomer/metallocene metal) ranging from 5 to 1000, preferentially from 10 to 500. Prior to its use in polymerization, the preformed catalytic system can be stored under an inert atmosphere, notably at a temperature ranging from −20° C. to room temperature (23° C.). According to this second embodiment, the preformed catalytic system has as its basic constituent a preformation monomer chosen from 1,3-dienes, ethylene and mixtures thereof. In other words, the “preformed” catalytic system contains a preformation monomer in addition to the metallocene and the co-catalyst. The 1,3-diene, as preformation monomer, may be 1,3-butadiene, isoprene or a 1,3-diene of formula CH₂═CR¹—CH═CH₂, the symbol R¹ representing a hydrocarbon-based group containing 3 to 20 carbon atoms, in particular myrcene or β-farnesene. The preformation monomer is preferentially 1,3-butadiene.

The catalytic system is typically present in a solvent which is preferentially the solvent in which it was prepared, and the concentration of rare-earth metal, i.e. neodymium, of the metallocene is then within a range preferentially from 0.0001 to 0.2 mol/L more preferentially from 0.001 to 0.03 mol/L.

Like any synthesis performed in the presence of an organometallic compound, the synthesis of the metallocene, the synthesis of the alkylmagnesium halide and the synthesis of the catalytic system take place under anhydrous conditions under an inert atmosphere. Typically, the reactions are performed starting with anhydrous solvents and compounds under anhydrous nitrogen or argon.

The polymerization of the monomer mixture is preferably performed in solution, continuously or batchwise. The polymerization solvent is typically an aromatic or aliphatic hydrocarbon-based solvent, such as toluene, cyclohexane or methylcyclohexane, or a mixture of two thereof, or even a mixture of the three. The monomer mixture may be introduced into the reactor containing the polymerization solvent and the catalytic system or, conversely, the catalytic system may be introduced into the reactor containing the polymerization solvent and the monomer mixture. The monomer mixture and the catalytic system may be introduced simultaneously into the reactor containing the polymerization solvent, notably in the case of a continuous polymerization. The polymerization is typically performed under anhydrous conditions and in the absence of oxygen, in the optional presence of an inert gas. The polymerization temperature generally ranges from 40 to 150° C., preferentially 40 to 120° C. A person skilled in the art adapts the polymerization conditions, such as the polymerization temperature, the concentration of each of the reagents and the pressure in the reactor, as a function of the monomer mixture composition, the polymerization reactor and the desired microstructure and macrostructure of the copolymer chain.

The polymerization is preferentially performed at constant monomer pressure. Continuous addition of each or one of the monomers may be performed in the polymerization reactor, in which case the polymerization reactor is a fed reactor. This embodiment is most particularly suitable for a statistical incorporation of the monomers.

According to a preferential embodiment of the invention, the polymerization in step a) is a statistical polymerization, which is reflected by the statistical incorporation of the monomers of the monomer mixture used in step a). This embodiment, which allows the preparation of statistical polymer chains in step a), is suitable for the synthesis of coupled statistical polymers.

According to another preferred embodiment of the invention, the polymerization in step a) comprises the statistical polymerization of a first monomer mixture containing ethylene and a 1,3-diene, followed by the polymerization of a second monomer mixture of different composition from the first monomer, for example because it is free of said 1,3-diene or of any 1,3-diene. This embodiment, which allows block polymer chains to be prepared in step a), is suitable for the synthesis of coupled block polymers.

Once the desired degree of monomer conversion has been achieved in the polymerization reaction of step a), step b) is performed.

Step b) of the process in accordance with the invention brings a coupling agent, a compound containing at least two nitrile functions, into contact with the reaction product of step a).

Preferably, step b) is also performed in a hydrocarbon-based solvent. Advantageously, it is performed in the reaction medium resulting from step a). It is generally performed by adding the compound containing at least two nitrile functions to the reaction product from step a) in its reaction medium with stirring.

Before adding the compound containing at least two nitrile functions, the reactor is preferably degassed and made inert (also said inertized). Degassing the reactor enables residual gaseous monomers to be removed, and also facilitates the addition of the compound containing at least two nitrile functions into the reactor. Making inert the reactor, for example with nitrogen, helps to prevent the carbon-metal bonds present in the reaction medium and necessary for the polymer coupling reaction from being deactivated. The compound containing at least two nitrile functions may be added neat or diluted in a hydrocarbon-based, aliphatic or aromatic solvent. The compound containing at least two nitrile functions is left in contact with the reaction product from step a), preferably with stirring, for the time required for the coupling reaction. The coupling reaction may typically be monitored by chromatographic analysis to track the consumption of the compound containing at least two nitrile functions. The coupling reaction is preferentially performed at a temperature ranging from 23° C. to 120° C., preferentially from 40° C. to 100° C.

The coupling reaction, step b), is preferentially performed with one molar equivalent of nitrile function relative to the number of carbon-magnesium bonds per mole of co-catalyst, the organomagnesium halide. However, the ratio between the number of molar equivalents of nitrile function and the number of carbon-magnesium bonds per mole of co-catalyst may vary according to the desired level of coupled polymer in the polymer obtained on conclusion of step c). A ratio close to 1, typically ranging from 0.95 to 1.05, favours the highest degrees of coupling. Typically, in an organomagnesium halide such as n-butylmagnesium chloride, there is one carbon-magnesium bond per mole of magnesium reagent; whereas in a diorganomagnesium reagent such as butyloctylmagnesium (BOMAG), there are two carbon-magnesium bonds per mole of magnesium reagent. One mole of a compound containing two nitrile functions is equivalent to two molar equivalents of nitrile function; more generally, one mole of a compound containing n nitrile functions is equivalent to n molar equivalents of nitrile function, n being an integer greater than or equal to 2.

The compound containing at least two nitrile functions may be an aliphatic compound or an aromatic compound, preferably an aromatic compound. The compound containing at least two nitrile functions is typically a compound having a hydrocarbon-based chain substituted with at least two nitrile functions. The hydrocarbon-based chain of the compound containing at least two nitrile functions may be linear, cyclic or branched.

According to any one of the embodiments of the invention, the compound containing at least two nitrile functions is a compound in which the number of nitrile functions is preferentially two or three, more preferentially two.

According to a first embodiment of the invention, the compound containing at least two nitrile functions is an alkane substituted with said nitrile functions, preferentially with two nitrile functions or three nitrile functions, more preferentially with two nitrile functions. The length of the hydrocarbon-based chain of the alkane substituted with a nitrile function is not inherently limited, and the number of carbon atoms in the hydrocarbon-based chain may vary widely, for example from 1 to 11 carbon atoms. The choice of an alkane substituted with at least two nitrile functions may be motivated by the fact that it is commercially available or readily synthesized. 1,2-dicyanoethane or succinonitrile, 1,3-dicyanopropane or glutaronitrile, 1,4-dicyanobutane or adiponitrile, 1,5-dicyanopentane, 1,6-dicyanohexane, 1,2,3-propanetricarbonitrile and 1,3,5-pentanetricarbonitrile are suitable for use, preferentially succinonitrile, glutaronitrile and adiponitrile.

According to a second particularly preferential embodiment, the compound containing at least two nitrile functions is a compound containing at least two nitrile functions, each being a substituent of a same or a different aromatic group. The compound containing at least two nitrile functions is more preferentially benzene substituted with said nitrile functions, preferably two nitrile functions or three nitrile functions, more preferentially two nitrile functions. For example, 1,3-dicyanobenzene, 1,4-dicyanobenzene and 1,3,5-tricyanobenzene, preferentially 1,3-dicyanobenzene and 1,4-dicyanobenzene are suitable for use.

Once the chain end has been modified, step b) is followed by step c). Step c) is typically a hydrolysis reaction which allows formation of the ketone function in the polymer chain and, where appropriate, deactivation of the reactive sites that are still present in the reaction medium. The hydrolysis reaction is generally performed by adding water to the reaction medium or vice versa, optionally in the presence of an acid. Typically, the reaction medium resulting from step b) is brought into contact with an aqueous hydrochloric acid solution. The hydrolysis reaction may be performed at a temperature ranging from 0° C. to 100° C., preferentially at room temperature (23° C.) or at the reaction temperature of step b), or even at a temperature in the range from room temperature to the reaction temperature of step b).

On conclusion of step c), the polymer may be separated from the reaction medium according to processes well known to those skilled in the art, for example by a solvent evaporation operation under reduced pressure or by a steam stripping operation or by precipitation of the polymer. According to a variant of the invention, step c) and the separation of the polymer from the reaction medium may be performed in the same operation, for example a steam stripping operation, notably in the presence of an acid.

The polymers that can be synthesized via the process in accordance with the invention have the feature of being coupled polymers, typically obtained by coupling reaction of polymer chains with a coupling agent, in this case the compound containing at least two nitrile functions. In a known manner, a coupled polymer is constituted of polymer chains which are covalently linked to each other via a group (or “moiety”). According to the invention, the group results from the coupling reactions between the polymer chains and the coupling agent, and from the hydrolysis reaction, which take place respectively during steps b) and c) of the process in accordance with the invention. A person skilled in the art will understand that the group is not to be confused with a monomer unit of the polymer. In the present case, the group contains at least two ketone functions. Each of the group's ketone functions is covalently bonded to a monomer unit of a different polymer chain. The polymers according to the invention thus consist of polymer chains linked together by said group. They contain more than 50 mol % of ethylene units and are polyethylenes, copolymers of ethylene and a 1,3-diene and optionally a vinylaromatic compound, preferentially styrene.

According to a preferred embodiment of the invention, the group containing at least two ketone functions is a group in which said ketone functions are each a substituent of a same or a different aromatic group, preferably a phenyl. The number of ketone functions of said group is advantageously two or three, very advantageously two.

Preferably, the copolymer also contains 1,2-cyclohexane ring units. The 1,2-cyclohexane ring units are of formula (IV).

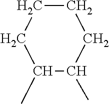

When the copolymer contains 1,2-cyclohexane ring units, it is a copolymer according to a particular embodiment of the invention in which the 1,3-diene is 1,3-butadiene or a mixture of 1,3-dienes, one of which is 1,3-butadiene and in which the ring units result from a particular insertion of the ethylene and 1,3-butadiene monomers into the polymer chain, in addition to the conventional ethylene and 1,3-butadiene units —(CH₂—CH₂)—, (CH₂—CH═CH—CH₂)— and (CH₂—CH(C═CH₂))— respectively. It is notably obtained via the process in accordance with the invention according to the embodiment in which the metallocene of the catalytic system has two substituted or unsubstituted fluorenyl groups as ligands. The mechanism for obtaining such a microstructure is described, for example, in Macromolecules 2009, 42, 3774-3779. When the polymer in accordance with the invention contains 1,2-cyclohexane ring units, it preferentially contains not more than 15 mol % thereof, the percentage being expressed relative to the total units resulting from polymerization of the monomers in the monomer mixture.

When the polymer in accordance with the invention is a polymer of several monomers, the constituent polymer chains of the polymer may be block or statistical chains.

According to the embodiment of the invention in which the constituent polymer chains of the polymer are statistical chains, the copolymer in accordance with the invention is statistical and can be obtained according to the particular embodiment of the process in accordance with the invention which includes in step a) the statistical polymerization of a monomer mixture.

According to the embodiment of the invention in which the constituent polymer chains of the polymer are block chains, the copolymer in accordance with the invention contains block chains and can be obtained according to the particular embodiment of the process in accordance with the invention which includes in step a) the statistical polymerization of a first monomer mixture containing ethylene and a 1,3-diene, followed by the polymerization of a second monomer mixture of different composition from the first monomer mixture, because it is, for example, free of the 1,3-diene.

The polymer in accordance with the invention, whether it is a copolymer or a polyethylene, can be used in compositions containing one or more ingredients or constituents other than the polymer in accordance with the invention, for example additives conventionally used in polymer compositions, such as antioxidants, plasticizers, pigments or fillers.

In summary, the invention is advantageously performed according to any one of the following embodiments 1 to 22:

Embodiment 1: Process for preparing a coupled polymer which contains more than 50 mol % of ethylene, expressed as a molar percentage relative to all of the monomer units of the polymer, the polymer being a polyethylene or a copolymer of ethylene and a 1,3-diene and optionally a vinylaromatic compound, which process comprises the successive steps a), b) and c):
step a) being a polymerization reaction of the monomers in the presence of a catalytic system based on at least one metallocene of formula (I) and an organomagnesium halide of formula (II)

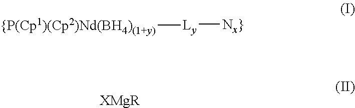

Cp¹ and Cp², which are identical or different, being chosen from the group consisting of fluorenyl groups, cyclopentadienyl groups and indenyl groups, the groups being substituted or unsubstituted,
P being a group bridging the two groups Cp¹ and Cp² and comprising a silicon or carbon atom,
Nd denoting the neodymium atom,
L representing an alkali metal chosen from the group consisting of lithium, sodium and potassium,
N representing a molecule of an ether,
x, which may or may not be an integer, being greater than or equal to 0,
y, which is an integer, being greater than or equal to 0,
X being a halogen atom and R being an alkyl,
step b) being the reaction of the reaction product of step a) with a compound containing at least two nitrile functions, each preferentially being a substituent of a same or a different aromatic group,
step c) being a hydrolysis reaction.

Embodiment 2: Process according to embodiment 1, in which the polymerization reaction is the polymerization of ethylene.

Embodiment 3: Process according to embodiment 1, in which the polymerization reaction is the copolymerization of a monomer mixture of ethylene and a 1,3-diene and optionally a vinylaromatic compound.

Embodiment 4: Process according to embodiment 3, in which the vinylaromatic compound is styrene.

Embodiment 5: Process according to embodiment 1 or either of embodiments 3 and 4, in which the 1,3-diene is 1,3-butadiene, isoprene, myrcene, β-farnesene or mixtures thereof.

Embodiment 6: Process according to embodiment 1 or either of embodiments 3 and 4, in which the monomer mixture of step a) contains more than 50 mol % of ethylene, the percentage being expressed relative to the total number of moles of monomers of the monomer mixture of step a).

Embodiment 7: Process according to any one of embodiments 1 to 6, in which Cp¹ and Cp², which are identical or different, are substituted fluorenyl groups or unsubstituted fluorenyl groups of formula C₁₃H₈, preferably unsubstituted fluorenyl groups.

Embodiment 8: Process according to any one of embodiments 1 to 7, in which the metallocene is of formula (I-1), (I-2), (I-3), (I-4) or (1-5):

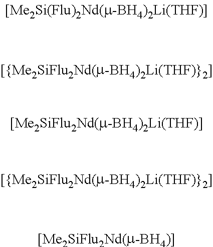

in which Flu represents the C₁₃H₈ group.

Embodiment 9: Process according to any one of embodiments 1 to 8, in which the ratio between the number of molar equivalents of nitrile function relative to the number of carbon-magnesium bonds per mole of organomagnesium halide ranges from 0.95 to 1.05.

Embodiment 10: Process according to any one of embodiments 1 to 9, in which step b) is performed with one molar equivalent of nitrile function relative to the number of carbon-magnesium bonds per mole of organomagnesium halide.

Embodiment 11: Process according to any one of embodiments 1 to 10, in which the alkylmagnesium halide is an alkylmagnesium chloride or an alkylmagnesium bromide, preferably an alkylmagnesium chloride.

Embodiment 12: Process according to any one of embodiments 1 to 11, in which the alkyl represented by the symbol R in formula (II) is a linear alkyl containing 2 to 10 carbon atoms.

Embodiment 13: Process according to any one of embodiments 1 to 12, in which the alkyl represented by the symbol R in formula (II) is ethyl, n-propyl, n-butyl, n-pentyl or n-octyl, more preferentially n-butyl.

Embodiment 14: Process according to any one of embodiments 1 to 13, in which the compound containing at least two nitrile functions is a hydrocarbon-based compound substituted with at least two nitrile functions.

Embodiment 15: Process according to any one of embodiments 1 to 14, in which the compound containing at least two nitrile functions is a compound in which the number of nitrile functions is two or three.

Embodiment 16: Process according to any one of embodiments 1 to 15, in which the compound containing at least two nitrile functions is an alkane substituted with said nitrile functions.

Embodiment 17: Process according to any one of embodiments 1 to 15, in which the compound containing at least two nitrile functions is a compound containing at least two nitrile functions, each being a substituent of a same or a different aromatic group.

Embodiment 18: Process according to any one of embodiments 1 to 15 or embodiment 17, in which the compound containing at least two nitrile functions is benzene substituted with said nitrile functions.

Embodiment 19: Coupled polymer, a polymer consisting of polymer chains which contain more than 50 mol % of ethylene units and which are linked together by a group containing at least two ketone functions, each of the ketone functions being covalently bonded to a monomer unit of a different polymer chain, which polymer is a polyethylene, a copolymer of ethylene and a 1,3-diene and optionally a vinylaromatic compound.

Embodiment 20: Coupled polymer according to embodiment 19, in which the group containing at least two ketone functions is a group in which said ketone functions are substituents of a same or a different aromatic group.

Embodiment 21: Coupled polymer according to embodiment 20, in which the aromatic group is a phenyl.

Embodiment 22: Coupled polymer according to any one of embodiments 19 to 21, which polymer is a copolymer of ethylene and a 1,3-diene and optionally a vinylaromatic compound and contains 1,2-cyclohexane ring units, the 1,3-diene being 1,3-butadiene or a mixture of 1,3-dienes, one of which is 1,3-butadiene.

The abovementioned features of the present invention, and also others, will be understood more clearly on reading the following description of implementation examples of the invention, which are given as non-limiting illustrations.

### EXAMPLES

### Characterization of the Polymers:

High temperature size exclusion chromatography (HT-SEC) to characterize the polyethylenes: The high temperature size exclusion chromatography (HT-SEC) analyses were performed with a Viscotek machine (Malvern Instruments) equipped with three columns (PLgel Olexis 300 mm×7 mm I. D. from Agilent Technologies) and three detectors (differential refractometer and viscometer, and light scattering). 200 μL of a solution of the sample at a concentration of 8 mg·mL⁻¹ were eluted in 1,2,4-trichlorobenzene using a flow rate of 1 mL·min⁻¹ at 150° C. The mobile phase was stabilized with 2,6-di(tert-butyl)-4-methylphenol (400 mg·L⁻¹). OmniSEC software was used for data acquisition and analysis. The number-average molar mass (Mn) and weight-average molar mass (Mᵥ) of the synthesized polyethylenes were calculated using a calibration curve obtained from standard polyethylenes (Mₚ: 338, 507, 770, 1890, 17 000, 27 300, 43 400, 53 100, 65 700, 78 400 g·mol⁻¹) from Polymer Standard Service (Mainz).

### Size Exclusion Chromatography THF (SEC-THF) to Characterize the Ethylene/1,3-Butadiene Copolymers:

The size exclusion chromatography analyses were performed using a Viscotek machine (Malvern Instruments) equipped with three columns (SDVB, 5 μm, 300×7.5 mm from Polymer Standard Service), a guard column and three detectors (differential refractometer and viscometer, and light scattering). 1 mL of a solution of the sample with a concentration of 5 mg·mL⁻¹ in THE was filtered through a 0.45 μm PTFE membrane. 100 μL of this solution were eluted in THE using a flow rate of 0.8 mL·min⁻¹ at a temperature of 35° C. OmniSEC software was used for data acquisition and analysis. The number-average molar mass (Mn) and weight-average molar mass (Mᵥ) of the synthesized ethylene/1,3-butadiene copolymers and the dispersity thereof (D) were calculated using a universal calibration curve obtained from standard polystyrenes (Mₚ: 1306 to 2 520 000 g·mol⁻¹) from Polymer Standard Service (Mainz).

### Nuclear Magnetic Resonance (NMR):

High resolution NMR spectroscopy of the polymers was performed on a Broker 400 Avance III spectrometer operating at 400 MHz equipped with a 5 mm BBFO probe for proton and on a BrOker 400 Avance II spectrometer operating at 400 MHz equipped with a 10 mm PSEX ¹³C probe for carbon. Acquisitions were made in a mixture of tetrachloroethylene (TCE) and deuterated benzene (C₆D₆) (2/1 v/v) at 363 K for the ethylene homopolymers, and in deuterated chloroform (CDCl₃) at 298 K for the ethylene/1,3-butadiene copolymers. The samples were analysed at a concentration of 1% by mass for proton and 5% by mass for carbon. The chemical shifts are given in ppm, relative to the deuterated benzene proton signal set at 7.16 ppm (or, respectively, relative to deuterated chloroform at 7.26 ppm) and the TCE carbon signal set at 120.65 ppm.

### Preparation of the Polymers:

The metallocene [{Me₂SiFlu₂Nd(μ-BH₄)₂Li(THF)}]₂ is prepared according to the procedure described in patent application WO 2007/054224.

The butyloctylmagnesium BOMAG (20% in heptane, at 0.88 mol·L⁻¹) is obtained from Chemtura and is stored in a Schlenk tube under an inert atmosphere.

Unless otherwise indicated, the magnesium halides are from Sigma-Aldrich.

The ethylene, of N35 grade, is obtained from the company Air Liquide and is used without prior purification.

The 1,3-butadiene is purified over alumina guard tubes. The toluene is purified over alumina guard tubes.

In the procedures described, the term “cannulate” means to transfer using a cannula.

### Synthesis of Coupled Polyethylenes:

### Example 1

198 mL of toluene taken from a solvent fountain (SPS800 MBraun) are placed in an inertized 250 mL round-bottomed flask equipped with a magnetized olive. 2.0 mL of a 2.0 M solution of butylmagnesium chloride in diethyl ether (4.0 mmol, 20 mM in 98/2 mol/mol toluene/diethyl ether mixture) are placed in the flask with stirring. 8.0 mg (12.5 μmol as neodymium) of {(Me₂Si(C₁₃H₃)₂)Nd(μ-BH₄)[(μ-BH₄)Li(THF)]}₂ are then added to the flask. The catalytic solution is cannulated into a 250 mL reactor under an inert atmosphere. The pressure in the reactor is reduced to 0.5 bar and the reactor is then pressurized to 4 bar of ethylene and the temperature is simultaneously brought to 80° C. The pressure is kept constant in the reactor by means of a tank containing ethylene. When the desired amount of ethylene has been consumed, in this case after 17 min, the reactor is degassed and 10 mL (5%) of the polymer solution are cannulated out of the reactor and the polymer is then precipitated from methanol, recovered by filtration and dried. It is designated PE1NF.

243 mg of 1,3-dicyanobenzene (1.9 mmol, 1 molar equivalent of nitrile function/carbon-Mg bond) dissolved in 5 mL of toluene are added to the polymer solution remaining in the reactor. After 40 min of stirring at 80° C., 3 mL of aqueous 15% hydrochloric acid solution are added to deactivate the system, and the temperature is reduced to 20° C. The polymer solution is poured onto methanol with stirring to precipitate the polymer. The precipitated polymer (PE1F) is filtered off, washed with methanol and then dried under vacuum at 80° C. and characterized. 4.44 g of polymer PE1F of formula H—(CH₂—CH₂)ₙ—C(O)—(C₆H₄)—C(O)—(CH₂—CH₂)ₙ—H and 0.22 g of polymer PE1NF of formula H—(CH₂—CH₂)ₙ—H from the sample collected prior to the coupling reaction are recovered. The proton NMR spectrum of polymer PE1F (TCE/C₆D₆ 2/1 v/v, 400 MHz, 363 K) reveals the methylene protons a to the ketone at δ=2.76 ppm (triplet, (CH₂—CH₂)ₙ—CH₂—C(O)—(C₆H₄)—C(O)—CH₂—(CH₂—CH₂)ₙ) and three aromatic proton signals at δ=7.26 ppm (triplet, 1H), 7.92 ppm (doublet, 2H), 8.43 ppm (singlet, 1H). The function content in polymer PE1F is calculated by normalizing the sum of the C(O)—CH₂—CH₂ and CH₃ signal integrals of the NMR spectrum to 5. Thus, in PE1F, 88% of the polymer chain ends are modified with a ketone. No side products were identified by NMR. Consequently, in PE1F, 88% of the polymer chains are coupled.

### Synthesis of Coupled Copolymers of Ethylene and 1,3-Butadiene:

### Example 2

199 mL of toluene taken from a solvent fountain (SPS800 MBraun) are placed in an inertized 250 mL round-bottomed flask equipped with a magnetized olive. 1.0 mL of a 2.0 M solution of butylmagnesium chloride in diethyl ether (2.0 mmol, 10 mM in the toluene/diethyl ether mixture) is placed in the flask with stirring. 32.0 mg (50 μmol as neodymium) of {(Me₂Si(C₁₃H₃)₂)Nd(μ-BH₄)[(μ-BH₄)Li(THF)]}₂ are then added to the flask. The catalytic solution is cannulated into a 250 mL reactor under an inert atmosphere. The pressure in the reactor is reduced to 0.5 bar, and the reactor is then pressurized to 4 bar with an 80/20 mol/mol ethylene/1,3-butadiene mixture and the temperature is simultaneously brought to 80° C. The pressure is kept constant in the reactor by means of a tank containing an 80/20 mol/mol ethylene/1,3-butadiene gas mixture. When the desired amount of monomers has been consumed, in this case after 33 min, the reactor is degassed and the temperature is reduced to 20° C. 10 mL (5%) of the polymer solution are cannulated out of the reactor and the polymer is then precipitated from methanol containing 2,6-di-tert-butyl-4-methylphenol, washed with methanol and dried under vacuum at 70° C. It is designated EBRiNF.

121 mg of 1,3-dicyanobenzene (0.95 mmol, 1 molar equivalent of nitrile function/carbon-Mg bond) dissolved in 5 mL of toluene are added to the polymer solution remaining in the reactor. After stirring for 40 min at 80° C., 3 mL of aqueous 15% hydrochloric acid solution are added to deactivate the system. The polymer solution is poured onto methanol with stirring to precipitate the polymer. The precipitated polymer (EBR1F) is filtered off, washed with methanol and then dried and characterized. 3.76 g of polymer EBR1F and 0.21 g of polymer EBRiNF from the sample collected prior to the coupling reaction are thus recovered.

### Example 3

The synthesis of polymer EBR2 is identical to that described in Example EBR1, except that:
the 1.0 mL of a 2.0 M solution of butylmagnesium chloride in diethyl ether is replaced with 0.5 mL of a 2.0 M solution of butylmagnesium chloride in diethyl ether (1.0 mmol, 5 mM in toluene/diethyl ether mixture);
the coupling reaction is performed by adding 5 mL of a 0.095 M solution of adiponitrile in toluene (0.475 mmol, 1 molar equivalent of nitrile function/carbon-Mg bond);
the deactivation reaction is performed after 15 minutes at 80° C. 13.86 g of polymer EBR2F and 0.67 g of polymer EBR2NF from the sample collected prior to the coupling reaction are recovered.

### Example 4

The synthesis of polymer EBR3 is identical to that described in Example EBR1, except that:
the 1.0 mL of a 2.0 M solution of butylmagnesium chloride in diethyl ether is replaced with 0.57 mL of a 0.88 M solution of BOMAG in heptane (0.5 mmol, 2.5 mM in toluene/heptane mixture);
the coupling reaction is performed by adding 5 mL of a 0.095 M solution of adiponitrile in toluene (0.475 mmol, 1 molar equivalent of nitrile function/carbon-Mg bond);
the deactivation reaction is performed after 15 minutes at 80° C. 14.10 g of polymer EBR3F and 0.75 g of polymer EBR3NF from the sample collected prior to the coupling reaction are recovered.

### Example 5

199 mL of toluene taken from a solvent fountain (SPS800 MBraun) are placed in an inertized 250 mL round-bottomed flask equipped with a magnetized olive. 0.5 mL of a 2.0 M solution of butylmagnesium chloride in diethyl ether (1.0 mmol, 5 mM in the toluene/diethyl ether mixture) is placed in the flask with stirring. 32.0 mg (50 μmol as neodymium) of {(Me₂Si(C₁₃H₃)₂)Nd(μ-BH₄)[(μ-BH₄)Li(THF)]}₂ are then added to the flask. The catalytic solution is cannulated into a 250 mL reactor under an inert atmosphere. The pressure in the reactor is reduced to 0.5 bar, and the reactor is then pressurized to 4 bar with an 80/20 mol/mol ethylene/1,3-butadiene mixture and the temperature is simultaneously brought to 80° C. The pressure is kept constant in the reactor by means of a tank containing an 80/20 mol/mol ethylene/1,3-butadiene gas mixture.

After 15 g of the ethylene/1,3-butadiene mixture have been consumed, the pressure in the reactor is reduced to 0.5 bar, the reactor is then pressurized to 4 bar of ethylene and the temperature is maintained at 80° C. After consuming 1 g of ethylene, the reactor is degassed and the temperature is reduced to 20° C. 10 mL (5%) of the polymer solution are cannulated out of the reactor, and the polymer is then precipitated from methanol containing 2,6-di-tert-butyl-4-methylphenol, washed with methanol and dried under vacuum at 70° C. It is designated EBR-b-PE1NF. The polymer chains prior to the coupling reaction are block polymer chains consisting of a statistical polymer block of ethylene and 1,3-butadiene and a polyethylene block. 5 mL of a 0.095 M solution of adiponitrile in toluene (0.475 mmol, 1 molar equivalent of nitrile function/carbon-Mg bond) are added to the polymer solution remaining in the reactor, and the reaction medium is then stirred at 80° C. for 1 hour.

After stirring for 40 min at 80° C., 3 mL of aqueous 15% hydrochloric acid solution are added to deactivate the system. The polymer solution is poured onto methanol with stirring to precipitate the polymer. The precipitated polymer (EBR-b-PE1) is filtered off, washed with methanol and then and characterized.

15.39 g of polymer EBR-b-PE1F and 0.88 g of polymer EBR-b-PE1NF from the sample collected prior to the coupling reaction are recovered.

The polymerization conditions are given in Table 1. Table 1 also shows for each example the catalytic activity calculated over the entire polymerization time and expressed in kg·mol⁻¹·h⁻¹. Table 1 also indicates the coupling agent used. The characteristics of the synthesized polymers are shown in Table 2. The SEC-THF method was used to determine the molar masses, and the microstructure of the polymers was determined by NMR. The ethylene unit content, the content of 1,3-butadiene unit in the 1,2-configuration (1,2-unit), in the 1,4-configuration (1,4-unit) and the content of 1,2-cyclohexane unit (ring unit) are expressed as molar percentages relative to the total monomer units of the polymer.

Examples 1, 2, 3 and 5 are in accordance with the invention. Example 4 is an example not in accordance with the invention due to the use of a co-catalyst which is not an alkylmagnesium halide, but a dialkylmagnesium reagent, in this case n-butyl-n-octylmagnesium (BOMAG).

The copolymers of Examples 2 and 3 are statistical. The copolymer of Example 4 is also statistical. The copolymer of Example 5 is a block copolymer, as it consists of coupled polymer chains, each of which consists of a statistical polymer block of ethylene and 1,3-butadiene and a polyethylene block.

TABLE 1

| | | Mg/Nd | Co-solvent | Time | Activity | |
|---|---|---|---|---|---|---|
| Polymer | Co-catalyst | ratio | (Et₂O/Mg) | (min) | (kg · mol⁻¹ · h⁻¹) | Coupling agent |
| PE1 | C₄H₉MgCl | 320 | 4.8 | 17 | 1050 | 1,3- |
| | | | | | | dicyanobenzene |
| EBR1 | C₄H₉MgCl | 40 | 4.8 | 33 | 140 | 1,3- |
| | | | | | | dicyanobenzene |
| EBR2 | BOMAG | 10 | 4.8 | 93 | 185 | Adiponitrile |
| EBR3 | C₄H₉MgCl | 20 | 4.8 | 100 | 175 | Adiponitrile |
| EBR-b-PE1 | C₄H₉MgCl | 20 | 4.8 | 90* | 180* | Adiponitrile |

*for the polymerization of the ethylene/1,3-butadiene polymer block

TABLE 2

| | Mₙ | | Mₚ** | Ethylene | | | |
|---|---|---|---|---|---|---|---|
| Polymer | (g · mol⁻¹) | Ð | (g · mol⁻¹) | unit | 1,2-Unit | 1,4-Unit | Ring unit |
| PE1NF | 1100 | 1.1 | 1200 | 100% | — | — | — |
| PE1F | 2000 | 1.2 | 2600 | 100% | — | — | — |
| EBR1NF | 1900 | 1.2 | 2300 | 73.2% | 9.7% | 6.5% | 10.6% |
| EBR1F | 2700 | 1.7 | 4400 | 73.4% | 9.5% | 6.4% | 10.7% |
| EBR2NF | 13 700 | 1.3 | 16 500 | 77.0% | 7.4% | 5.5% | 10.2% |
| EBR2F | 11 000 | 1.6 | 16 500; | 76.3% | 7.6% | 5.6% | 10.5% |
| | | | 33 000 | | | | |
| EBR3NF | 13 400 | 1.5 | 16 300 | 76.0% | 7.9% | 5.6% | 10.5% |
| EBR3F | 11 500 | 1.8 | 14 000 | 75.9% | 7.9% | 5.8% | 10.4% |
| EBR-b-PE1NF | 12 800 | 1.6 | 23 000 | — | — | — | — |
| EBR-b-PE1F | 14 200 | 2.0 | 23 000; | — | — | — | — |
| | | | 47 900 | | | | |

**Mp peak molar mass: for EBR2F and EBR-b-PE1F, bimodal distribution.

Whether the polymers are polyethylenes or diene copolymers that are rich in ethylene, it is observed that the process in accordance with the invention does indeed lead to the synthesis of coupled polymers.

Specifically, in Examples 2, 3 and 5, the coupled polymers EBR1F, EBR2F and EBR-b-PE1F show a peak molar mass that is about twice as high as the peak molar mass measured in the polymer prior to the coupling reaction (EBRINF, EBR2NF and EBR-b-PE1NF, respectively).

On the other hand, the use as co-catalyst of a dialkylmagnesium reagent such as BOMAG (Example 4, EBR3F) does not allow the production of coupled polymers.

Moreover, the use of a coupling agent whose nitrile functions are substituents of benzene also leads to the coupling of chains with the best yields. Specifically, in the case of polyethylene, the degree of coupling quantified by NMR is close to 90% (Example 1, PE1F) and in the case of a copolymer of ethylene and 1,3-butadiene, a single peak molar mass is determined (Example 2, EBR1F). No side products are detected, which also reflects a coupling reaction according to a selective process in the case of using a coupling agent containing at least two nitrile functions, each substituting an aromatic group.

What is claimed is:

1. A process for preparing a coupled polymer which contains more than 50 mol % of ethylene, expressed as a molar percentage relative to all of the monomer units of the polymer, the polymer being a polyethylene or a copolymer of ethylene and a 1,3-diene and optionally a vinylaromatic compound, which process comprises successive steps a), b) and c):
step a) being a polymerization reaction of the monomers in the presence of a catalytic system based on at least one metallocene of formula (I) and an organomagnesium halide of formula (II) 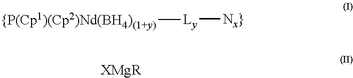
Cp¹ and Cp², which are identical or different, being chosen from the group consisting of fluorenyl groups, cyclopentadienyl groups and indenyl groups, the groups being substituted or unsubstituted,
P being a group bridging the two groups Cp¹ and Cp² and comprising a silicon or carbon atom,
Nd denoting the neodymium atom,
L representing an alkali metal chosen from the group consisting of lithium, sodium and potassium,
N representing a molecule of an ether,
x, which may or may not be an integer, being greater than or equal to 0,
y, which is an integer, being greater than or equal to 0,
X being a halogen atom and R being an alkyl,
step b) being the reaction of the reaction product of step a) with a compound containing at least two nitrile functions,
step c) being a hydrolysis reaction.

2. The process according to claim 1, in which the polymerization reaction is the polymerization of ethylene, the copolymerization of a monomer mixture of ethylene and a 1,3-diene and optionally a vinylaromatic compound.

3. The process according to claim 1, in which the 1,3-diene is 1,3-butadiene, isoprene, myrcene, β-farnesene or mixtures thereof.

4. The process according to claim 1, in which Cp¹ and Cp², which are identical or different, are substituted fluorenyl groups or unsubstituted fluorenyl groups of formula C₁₃H₈.

5. The process according to claim 1, in which the alkylmagnesium halide is an alkylmagnesium chloride or an alkylmagnesium bromide.

6. The process according to claim 1, in which the alkyl represented by the symbol R in formula (II) is a linear alkyl containing 2 to 10 carbon atoms.

7. The process according to claim 1, in which the alkyl represented by the symbol R in formula (II) is ethyl, n-propyl, n-butyl, n-pentyl or n-octyl.

8. The process according to claim 1, in which the compound containing at least two nitrile functions is a hydrocarbon-based compound substituted with at least two nitrile functions.

9. The process according to claim 1, in which the compound containing at least two nitrile functions is a compound in which the number of nitrile functions is two or three.

10. The process according to claim 1, in which the compound containing at least two nitrile functions is an alkane substituted with said nitrile functions.

11. The process according to claim 1, in which the compound containing at least two nitrile functions is a compound containing at least two nitrile functions, each being a substituent of a same or a different aromatic group.

12. The process according to a claim 1, in which the compound containing at least two nitrile functions is benzene substituted with said nitrile functions.

13. A coupled polymer, the polymer comprising polymer chains which contain more than 50 mol % of ethylene units and which are linked together by a group containing at least two ketone functions, each of the ketone functions being covalently bonded to a monomer unit of a different polymer chain, which polymer is a polyethylene, a copolymer of ethylene and a 1,3-diene and optionally a vinylaromatic compound.

14. The coupled polymer according to claim 13, in which the group containing at least two ketone functions is a group in which said ketone functions are each a substituent of a same or a different aromatic group.

15. The coupled polymer according to claim 14, in which the aromatic group is a phenyl.

16. The process according to claim 1, in which the at least two nitrile functions are a substituent of a same or a different aromatic group.

17. The process according to claim 1, in which the vinylaromatic compound is styrene.

18. The process according to claim 1, in which the Cp¹ and Cp² are unsubstituted fluorenyl groups.

19. The process according to claim 1, in which the alkylmagnesium halide is an alkylmagnesium chloride.

20. The process according to claim 1, in which the alkyl represented by the symbol R in formula (II) is n-butyl.
